(19) United States
(12) Patent Application Publication
(10) Pub. No.: US 2026/0244643 A1
(43) Pub. Date: Aug. 20, 2026

(54) ENGINEERING TOOL

(71) Applicant: KABUSHIKI KAISHA TOSHIBA, Tokyo (JP)

(72) Inventor: Harumi HOZOJI, Fuchu Tokyo (JP)

(73) Assignee: KABUSHIKI KAISHA TOSHIBA, Tokyo (JP)

(21) Appl. No.: 19/390,785

(22) Filed: Nov. 17, 2025

Related U.S. Application Data
(63) Continuation of application No. PCT/JP2024/014040, filed on Apr. 5, 2024.

(30) Foreign Application Priority Data
May 18, 2023 (JP) 2023-082104

(51) Int. Cl. G06F 16/27

(52) U.S. Cl. CPC G06F 16/27

(57) ABSTRACT

The efficiency of importing a control program is improved. An engineering tool includes an importer that imports a plurality of structures each having at least one variable or array, in which the importer determines an import order so as to import a structure that refers to another structure among the plurality of structures later than another structure of the plurality of structures, and imports the plurality of structures in the determined import order.

### CROSS REFERENCE TO RELATED APPLICATIONS

This application is based upon and claims the benefit of priority from the prior Japanese Patent Application No. 2023-082104, filed on May 18, 2023, the entire contents of which are incorporated herein by reference.

### FIELD

Embodiments of the present invention relate to an engineering tool.

### BACKGROUND

In general, in a plant control system, a system programmer creates a control program for a control device and provides the control program to a plant operator after testing and adjustment. When a similar plant control system is newly constructed, the system programmer may reuse a part or all of the components of the control program. Specifically, the system programmer exports a part or all of the components of the control program from the original plant control system, and imports into a newly created similar plant control system a control program created by reusing the part or all of the components that have been exported.

### BRIEF DESCRIPTION OF DRAWINGS

FIG. 1 is a system configuration diagram illustrating an example of an engineering tool and a peripheral portion thereof according to an embodiment of the present disclosure.

FIG. 2 is a diagram schematically illustrating a configuration of a database.

FIG. 3 is a block diagram illustrating a detailed configuration of an operation screen and the database.

FIG. 4 is a configuration example of a library database.

FIG. 5 is a configuration example of a data type database.

FIG. 6 is a configuration example of a user data type member database.

FIG. 7 is a configuration example of a variable database.

FIG. 8 is a configuration example of a program code database.

FIG. 9 is a ladder diagram illustrating functions.

FIG. 10 is a ladder diagram illustrating function blocks.

FIG. 11 is a ladder diagram illustrating a program.

FIG. 12 is a diagram illustrating an image of activating an importer.

FIG. 13 is a diagram illustrating an example of a screen of the importer.

FIG. 14A is a diagram illustrating an import order in an initial state of a group of import target files.

FIG. 14B is a diagram illustrating an import order according to a reference relationship of each import target file.

FIG. 15 is a flowchart of import order calculation according to the embodiment of the present disclosure.

FIG. 16 is an example of a message window describing non-importability output by the importer.

FIG. 17 is a flowchart of overall import in an embodiment of the present disclosure.

FIG. 18 is a flowchart of import order calculation of a structure.

FIG. 19 is a flowchart of import order calculation of functions and function blocks.

FIG. 20 is a flowchart of calculation of an import order of a program.

FIG. 21 is a flowchart of import processing.

### DETAILED DESCRIPTION

### Embodiments of Present Disclosure

Components of the control program include a program, a function block, a function, and a user data type. These have a reference relationship. For example, the function block may further refer to a function block. In the import of the control program, the system programmer needs to strictly follow the order of the import based on this reference relationship.

Further, in the export of the components of the control program, the system programmer needs to select a necessary program, function block, function, and user data type. For this reason, when the components of the control program are exported, the system programmer needs to investigate in advance the program, the function block, the function, and the user data type necessary for the configuration of the control program. In addition, when the function block further refers to the function block, it takes time to investigate.

When a large amount of control programs are exported or a large amount of control programs are imported, it takes time to investigate the order of import and the components that need to be exported, which causes a problem that work efficiency deteriorates.

Therefore, the present embodiment provides an engineering tool that can efficiently import a control program.

The engineering tool according to the present embodiment includes:
an importer that imports a plurality of structures each having at least one variable or array, in which
the importer determines an import order so as to import a structure that refers to another structure among the plurality of structures later than another structure of the plurality of structures, and imports the plurality of structures in the determined import order.

Hereinafter, an embodiment of the present invention will be described with reference to the drawings.

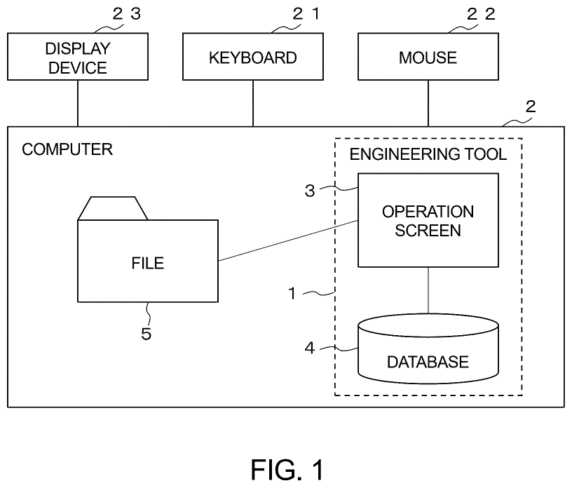

FIG. 1 is a system configuration diagram illustrating an example of an engineering tool 1 and a peripheral portion thereof according to an embodiment of the present disclosure. The engineering tool 1 illustrated in FIG. 1 is disposed in, for example, a computer 2.

The engineering tool 1 is used, for example, for development of a control program. The control program developed in the engineering tool 1 is applied to a plant control device or the like. The engineering tool 1 includes an operation screen 3 and a database (storage unit) 4. The operation screen 3 provides a system programmer (also referred to as a user) with an operation function of the engineering tool 1. In the present specification, an example in which the operation screen 3 is configured by a graphical user interface (GUI) will be described, but it is not limited thereto. The operation screen 3 may include a character user interface (CUI) or the like. The database 4 stores the control program created via the operation screen 3.

Further, the engineering tool 1 also has a control program import and export function. The engineering tool 1 can export the control program as a file 5 in the computer 2. The export of the control program is to export a part or all of the components constituting the control program. In addition, the engineering tool 1 can import a part or all of the components constituting the control program from any file 5 in the computer 2.

The computer 2 includes, for example, a keyboard 21, a mouse 22, and a display device 23 as peripheral devices. The system programmer can operate the operation screen 3 with the keyboard 21 and the mouse 22. In addition, the system programmer can confirm the operation screen 3 by the display device 23.

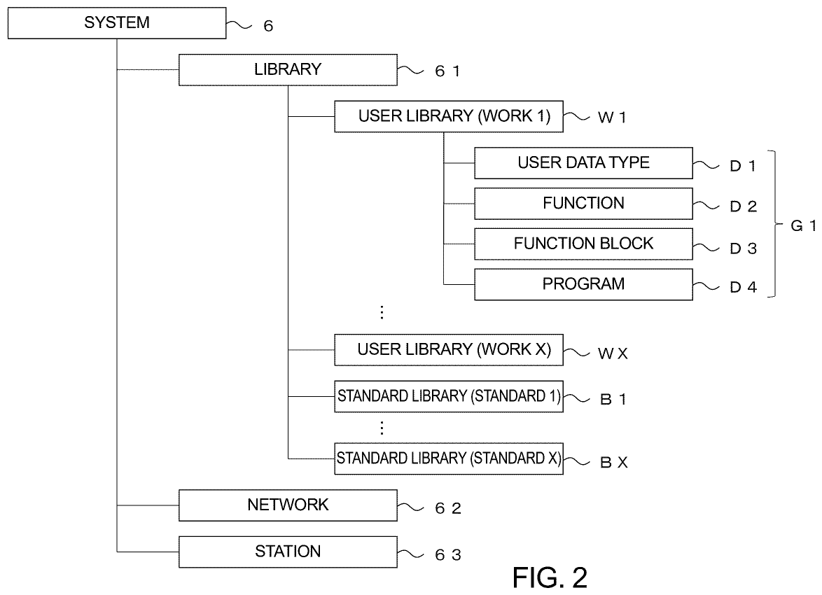

FIG. 2 is a diagram schematically illustrating a configuration of the database 4. The system 6 illustrated in FIG. 2 includes a library 61, a network 62, and a station 63. The library 61 stores one or a plurality of control programs. The library 61 includes a plurality of user libraries W1 to WX created for each user and a plurality of standard libraries B1 to BX that can be shared among users.

Each of the plurality of user libraries (and a plurality of standard libraries) has a control program including a user data type, a function, a function block, and a program. For example, the user library W1 includes a control program G1 including a user data type D1, a function D2, a function block D3, and a program D4. Note that the control program may have multiple user data types, functions, function blocks, or programs. Further, each of the plurality of user libraries has user information.

The user data type has one or more variables (variable members), and is also called a structure. The user data type is used in a program, a function block, and a function. In addition, the user data type may include another user data type as a variable member.

The function is a function having no history. The functions are called from programs and function blocks. In addition, the function can call another function.

The function block is a function having a history property. The function block is called from a program. In addition, the function block can call another function block.

The program specifies an operation procedure for causing the control device or the like to perform a predetermined operation.

As described above, a program, a function block, or a function may call another function block or function. In addition, the program, the function block, the function, and the user data type may include other user data types therein. A relationship in which one component calls or includes another component is also referred to as a reference relationship. For example, a program calling a function block is also referred to as a program referring to the function block.

The network 62 has connection information between a plurality of control devices to which the control program is applied, or connection information between the control device and another device.

The station 63 has hardware information of a control device to which the control program is applied. The hardware information includes, for example, a model name of the control device, an execution cycle of the control program, and the like.

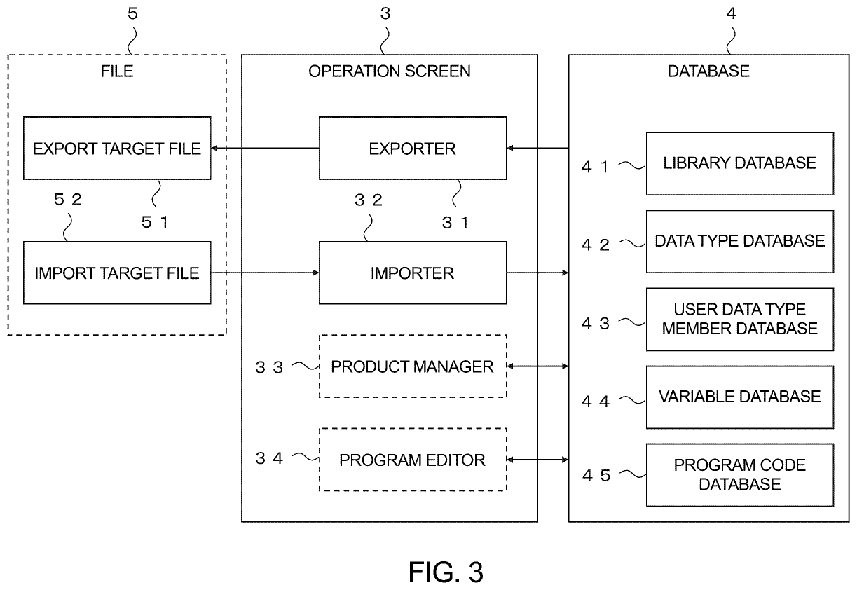

FIG. 3 is a block diagram illustrating a detailed configuration of the operation screen 3 and the database 4. The operation screen 3 includes an exporter 31 and an importer 32.

The exporter 31 acquires some or all of the components of one or a plurality of control programs from the database 4, and outputs one or a plurality of export target files 51 (files 5) each including the acquired components.

The importer 32 reads one or a plurality of import target files 52 (files 5) as one or a plurality of control programs to be imported. Each of the import target files 52 includes one or a plurality of components of a control program. The importer 32 writes (imports) the components included in the read import target file 52 (file 5) to the database 4. Thus, the importer 32 writes one or a plurality of control programs to the database 4.

Note that a part or all of the import target files 52 to be imported by the importer 32 may be the export target file 51 output by the exporter 31. In this case, the user can select the export target file 51 output from the exporter 31 as a part or all of the import target files 52.

The operation screen 3 may include a product manager 33 that manages the system 6 and the like in FIG. 2. The product manager 33 acquires information of the system 6 from the database 4 and writes a change content of the system 6 in the database 4. Further, the operation screen 3 may have a program editor 34 for editing the control program. The program editor 34 acquires the control program from the database 4 and writes the change content of the control program in the database 4.

The database 4 manages information of the library 61 in the system 6 by dividing the information into library data, data type data, data type member data, variable data, and program code data. Details of each piece of data and a correspondence relationship with the control program and the like in FIG. 2 will be described later. The library data, the data type data, the data type member data, the variable data, and the program code data are stored in a library database 41, a data type database 42, a user data type member database 43, a variable database 44, and a program code database 45, respectively.

Note that, in addition to the above, the database 4 may have a database that stores information of the network 62 and information of the station 63.

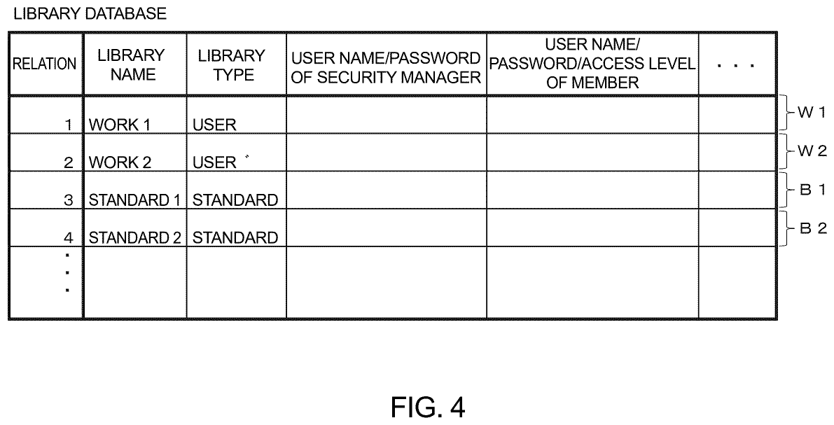

FIG. 4 is a configuration example of the library database 41. The library database 41 stores an aggregate of library data. The library data in the library database 41 includes a relation, a library name, a library type, information of a security manager, and information of a member.

The relation is a number uniquely allocated to each library data in order to associate each library data with another database.

The library name is a name indicating each library. The library name is set by the user, for example. The library type indicates a type of the library. The library type includes, for example, a user library and a standard library.

The library data includes a user name and a password of the security manager as information of the security manager. The security manager is a user in charge of security management of the library. The security manager can designate other users as members and allow access to the library. In addition, the security manager can also set access levels for each member. Examples of the access level include an inaccessible level, a level at which only the library is available, a level at which the library can be browsed and used, and a level at which the library can be edited, browsed, and used. In addition, the library data includes a user name, a password, and an access level of the member as information of the member. Note that FIG. 4 omits the contents of the information of the security manager and the information of the members.

In the library database 41 of FIG. 4, a user library (work 1) W1 and a standard library (standard 1) B1 of FIG. 2 are registered as library data. In addition, FIG. 4 illustrates an example in which a user library (work 2) W2 and a standard library (standard 2) B2 are registered in addition to these. 1, 2, 3, and 4 are allocated to the relations of the user libraries W1 and W2 and the standard libraries B1 and B2, respectively.

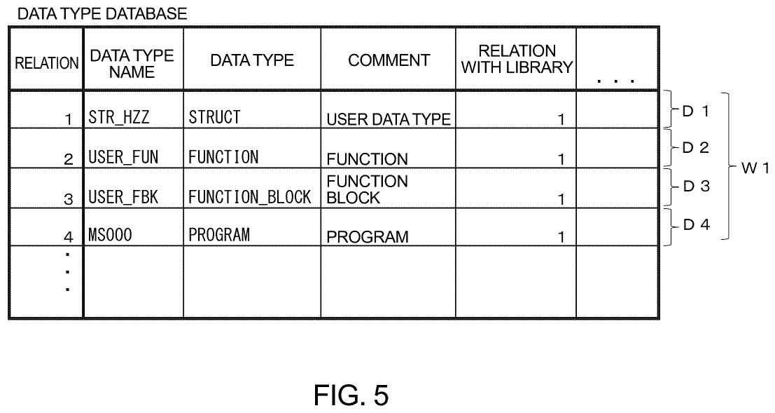

FIG. 5 is a configuration example of the data type database 42. The data type database 42 stores an aggregate of data (data type data) related to a data type. The data type data in the data type database 42 has a relation, a data type name, a data type, a comment, and a relation with a library.

The data type name is a name indicating each data type. The data type name is set by a user, for example. The data type indicates a type of the data type. Examples of the data type include STRUCT indicating a user data type, FUNCTION_BLOCK indicating a function block, FUNCTION indicating a function, and PROGRAM indicating a program. The comment is an explanatory sentence of each data type, and is set by the user, for example. The relation with the library associates the library data of FIG. 4 with the data type data of FIG. 5.

In FIG. 5, a user data type (STR_HZZ) D1, a function (USER_FUN) D2, a function block (USER_FBK) D3, and a program (MS000) D4 to which 1, 2, 3, and 4 are allocated as relations are registered. In each of the relations with the libraries of the user data type D1, the function D2, the function block D3, and the program D4, 1 is designated. That is, the user data type D1, the function D2, the function block D3, and the program D4 are associated with the user library W1 in FIG. 4.

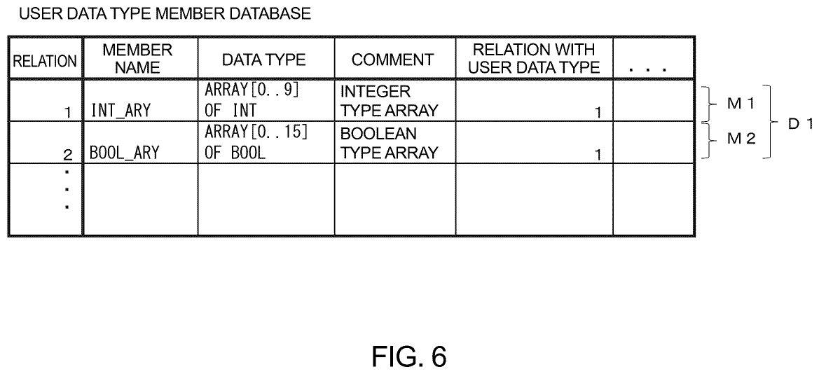

FIG. 6 is a configuration example of the user data type member database 43. The user data type member database 43 stores an aggregate of user data type member data. The user data type member data in the user data type member database 43 has a relation, a member name, a data type, a comment, and a relation with a user data type. The member name is a name indicating each member, and is set by the user, for example.

In FIG. 6, a member (INT_ARY) M1 and a member (BOOL_ARY) M2 to which 1 and 2 are allocated as relations are registered. In each of the relations with the user data types of the member M1 and the member M2, 1 is designated, and thus the member M1 and the member M2 are associated with the user data type D1 in FIG. 5. That is, the user data type D1 refers to the members M1 and M2. Note that, as described above, the user data type may include another user data type as a member.

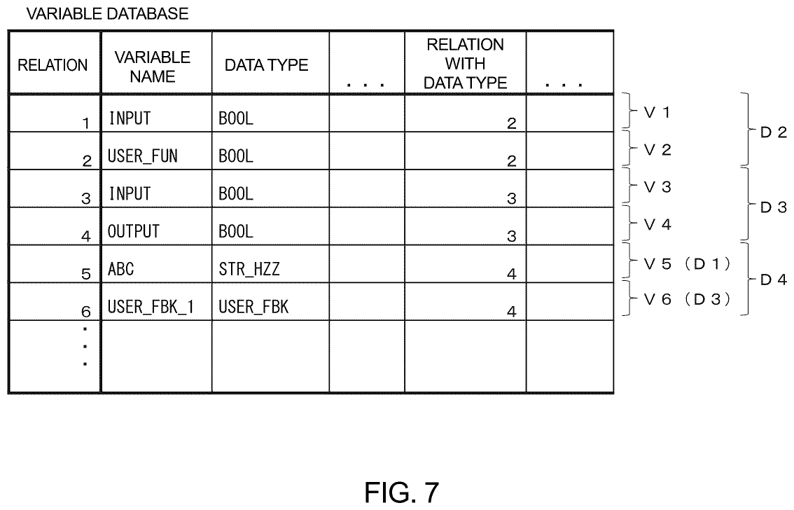

FIG. 7 is a configuration example of the variable database 44. The variable database 44 stores an aggregate of variable data. The variable data in the variable database 44 has a relation, a variable name, a data type, and a relation with a data type in the data type database 42. The variable name is a name indicating each variable, and is set by the user, for example. As the data type in FIG. 7, a data type (for example, BOOL) included in the engineering tool 1 as a standard or data type data stored in the data type database 42 is designated.

In FIG. 7, a variable (INPUT) V1, a variable (USER_FUN) V2, a variable (INPUT) V3, a variable (OUTPUT) V4, a variable (ABC) V5, and a variable (USER_FBK_1) V6 to which 1, 2, 3, 4, 5, and 6 are allocated as relations are registered. In each of the relations with the data types in the data type database 42, 2 is designated for the variables V1 and V2, 3 is designated for the variables V3 and V4, and 4 is designated for the variables V5 and V6. That is, the variables V1 and V22 are associated with the function D2, the variables V3 and V4 are associated with the function block D3, and the variables V5 and V6 are associated with the program D4.

Furthermore, since STR_HZZ is designated as the data type of the variable V5, the variable V5 refers to the user data type D1. Similarly, USER_FBK is designated as the data type of the variable V6, and the function block D3 is referred to. That is, the program D4 associated with the variable V5 and the variable V6 refers to the user data type D1 and the function block D3.

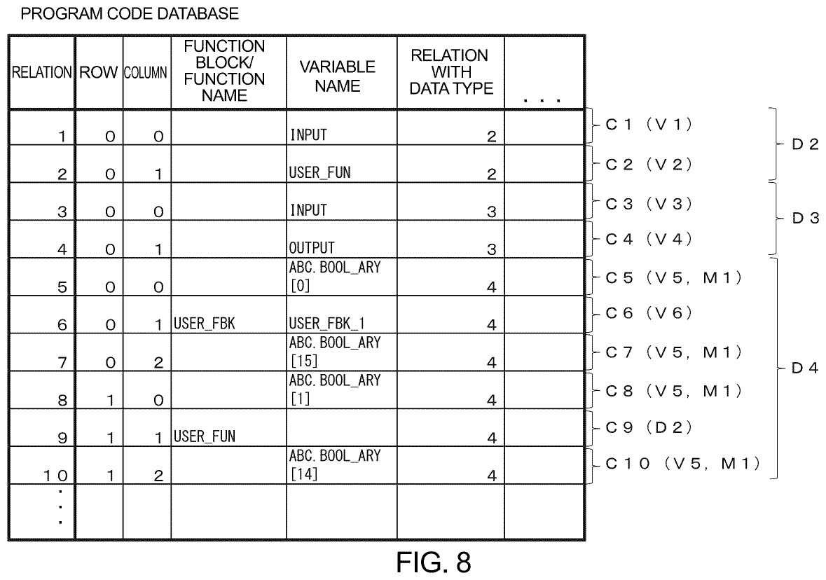

FIG. 8 is a configuration example of the program code database 45. The program code database 45 stores an aggregate of program codes. An aggregate of these program codes corresponds to the control program. Each program code data stores where each variable, function, and function block is disposed in the program, function block, or function. The program code data has a row, a column, a function/function block name, a variable name, and a relation with a data type.

The rows and columns indicate the positions of the respective variables and functions. In addition, the data type data in the data type database 42 and the program code data are associated with each other by the function/function block name. In addition, the variable data in the variable database 44 and the program code data are associated with each other by the variable name and the relation with the data type in the data type database 42.

In FIG. 8, program code data (program codes) C1 to C10 to which 1 to 10 is allocated as a relation are registered. The program codes C1 and C2 indicate that the variable V1 is arranged at the position of the row 0, column 0, and the variable V2 is arranged at the position of the row 0, column 1 in the function D2. The program codes C3 and C4 indicate, in the function block D3, that the variable V3 is arranged at the position of the row 0, column 0, and the variable V4 is arranged at the position of the row 0, column 1.

Each of the program codes C5, C7, C8, and C10 indicates the arrangement position of the member M1 of the variable V5 (user data type D1). The program codes C5, C7, C8, and C10 indicate that the member M1 is arranged at the positions of the row 0 column 0, the row 0 column 2, the row 1 column 0, and the row 1 column 2 in the program D4, respectively. The program code C6 indicates that the variable V6 (function block D3) is arranged in row 0, column 1 of the program D4.

The program code C9 indicates that function D2 is arranged in row 1 column 1 of the program D4. That is, the program D4 refers to the function D2.

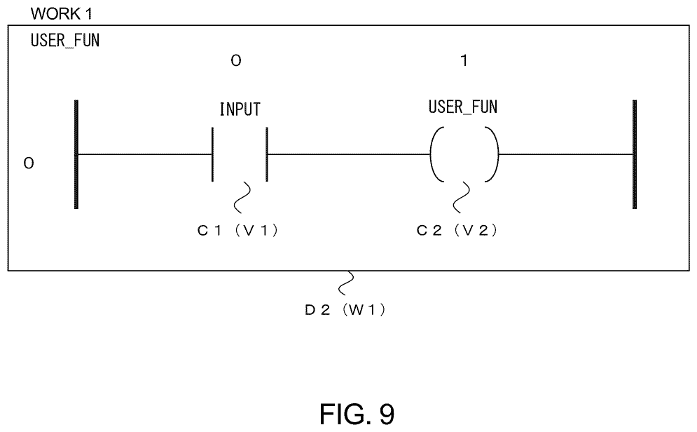

FIG. 9 is a ladder diagram illustrating the function D2. The ladder diagram of FIG. 9 is generated by, for example, the program editor 34 on the basis of the program code database 45 and the like. Furthermore, the change made by the program editor 34 is reflected in the program code database 45 and the like.

In FIG. 9, column data (column 0, column 1) is arranged in the horizontal direction, and row data (row 0) is arranged in the vertical direction. In the function D2 of FIG. 9, as illustrated in FIG. 8, the variable V1 is arranged in row 0, column 0, and the variable V2 is arranged in row 0, column 1.

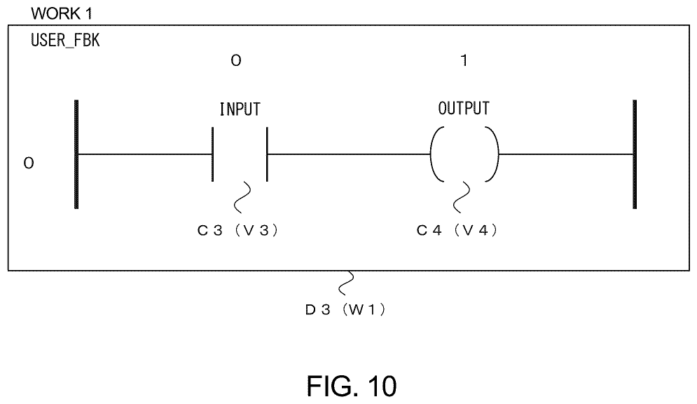

FIG. 10 is a ladder diagram illustrating the function block D3. In the function block D3 in FIG. 10, as illustrated in FIG. 8, the variable V3 is arranged in row 0, column 0, and the variable V4 is arranged in row 0, column 1.

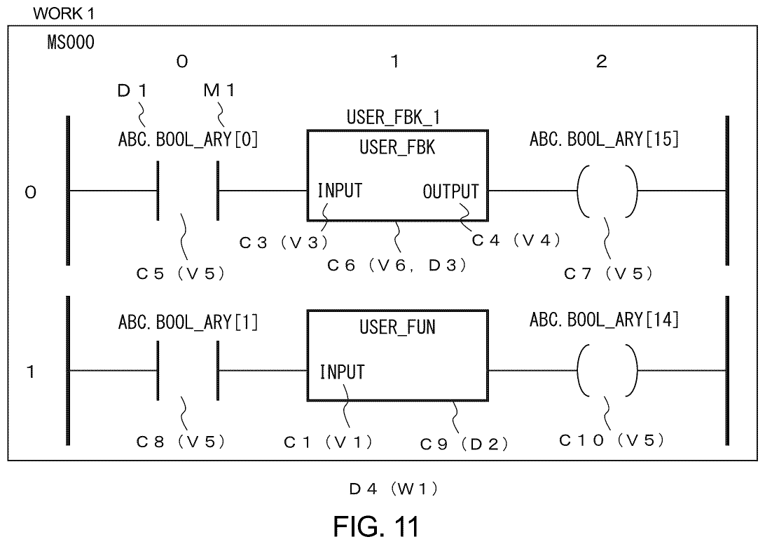

FIG. 11 is a ladder diagram illustrating the program D4. In the program D4 of FIG. 11, as illustrated in FIG. 8, the member M1 of the variable V5 is arranged in all of the row 0 column 0, the row 0 column 2, the row 1 column 0, and the row 1 column 2. The variable V6 (function block D3) is arranged in row 0, column 1. The variable V3 is assigned to the input unit of the variable V6, and the variable V4 is assigned to an output unit. The function D2 is arranged in row 1, column 1. The variable V1 is assigned to an input unit of the function D2.

As described above, the user data type, the function block, the function, and the program constituting the control program are registered in the database 4. The importer 32 can store the control program acquired from the import target files 52 in the database 4 in the format illustrated in FIGS. 4 to 8.

Further, the exporter 31 can acquire the control program from database 4, and output the control program as an export target file 51. In the case of the database examples in FIGS. 5 to 8, a file of the user data type D1 (file including data indicated by D1 in the database in FIG. 6), a file of the function D2 (file including data indicated by D2 in the database in FIGS. 7 and 8), a file of the function block D3 (file including data indicated by D3 in the database in FIGS. 7 and 8), and a file of the program D4 (file including data indicated by D4 in the database in FIGS. 7 and 8) can be output as an export target file 51. Although the above illustrates an example in which one file is exported for each data type, for example, if a plurality of user data types is defined in the data type database of FIG. 5, a plurality of files of the user data type may be exported. Similarly, when each of functions, function blocks, and programs is defined in plurality, a plurality of files can be exported.

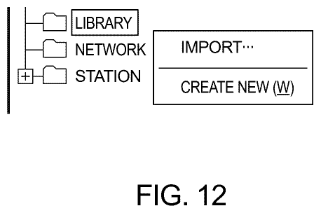

FIG. 12 is a diagram illustrating an image of activating the importer 32. The system programmer can invoke the importer 32, for example, from the product manager 33. For example, the system programmer can call the importer 32 by clicking import from the menu in FIG. 12.

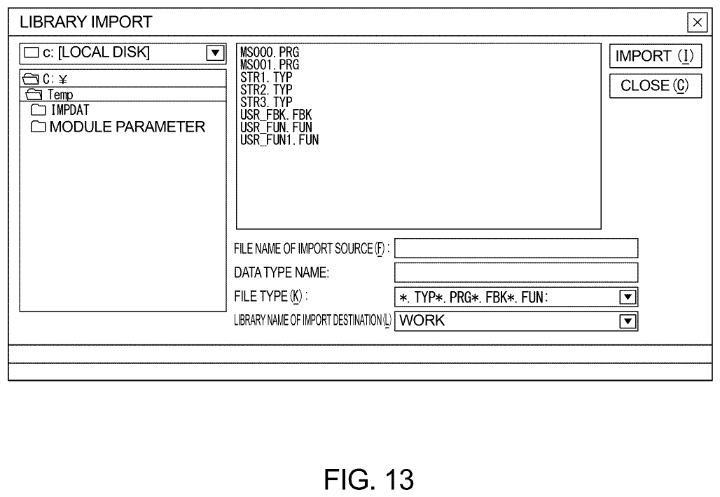

FIG. 13 is a diagram illustrating an example of a screen of the importer 32. The system programmer can search for the file 5, for example, from Explorer. The system programmer selects one or more files 5 from the search result and designates the file 5 as the import target file 52. The importer 32 imports data (structure, function, function block, program, and the like) from the specified import target file 52. The file specified as the import target file 52 may be a file exported from any control program, may be a file separately created by a user (for example, a system programmer) and stored in the database 4 or another storage unit, or may be both of them. Note that the library of the import destination is specified in advance. One or more pieces of data may be previously imported into the library of the import destination. That is, when the import operation is performed multiple times, data (structure, function, function block, program, and the like) imported up to the previous operation may be stored in the designated library.

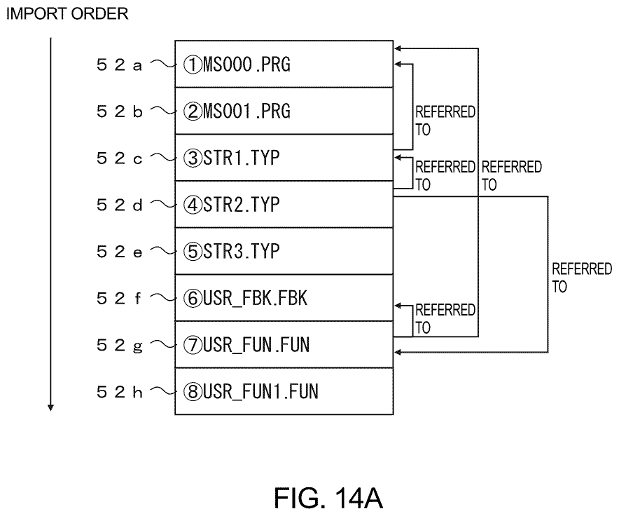

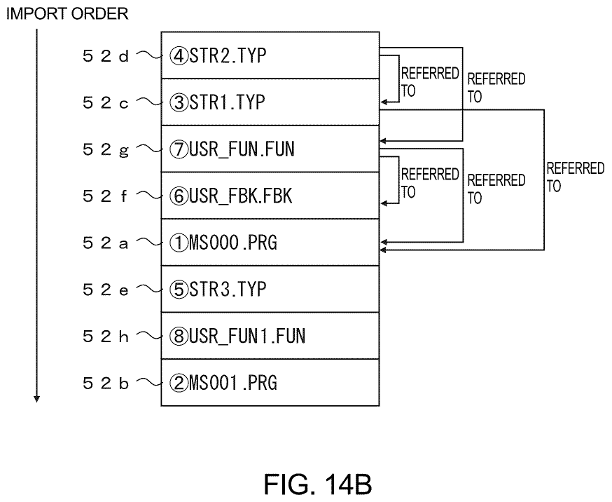

FIG. 14A is a diagram illustrating an import order in an initial state of the group of import target files 52 designated as import targets. In the initial state, the import order of each import target file 52 is, for example, the order specified by the system programmer. FIG. 14A illustrates the import target files 52a, 52b, 52c, 52d, 52e, 52f, 52g, and 52h in the import order in the initial state.

In order to successfully import each import target file 52, the import order of each import target file 52 needs to be set according to the reference relationship between respective import target files 52, more specifically, the reference relationship between pieces of data (structure, function, function block, program, and the like) included in each import target file 52. For example, the program stored in the import target file (MS000.PRG) 52a refers to the structure stored in the import target file (STR1.TYP) 52c and the function stored in the import target file (USR_FUN.FUN) 52g. Therefore, the importer 32 needs to import the import target files 52c and 52g before the import target file 52a. To import the import target file 52 means to import data (structure, function, function block, program, and the like) stored in the import target file 52.

However, the import order in FIG. 14A is not the order according to the reference relationship of each import target file 52. In the import order of FIG. 14A, the import order of the import target files 52c and 52g is later than the import target file 52a. Therefore, when the import is executed in the import order of FIG. 14A, the import of the import target file 52a fails.

Similarly, in FIG. 14A, the structure stored in the import target file 52c refers to the structure stored in the import target file (STR2.TYP) 52d. In addition, the function stored in the import target file 52g refers to the structure stored in the import target file 52d. Further, the function block stored in the import target file (USR_FBK.FBK) 52f refers to the function stored in the import target file 52g. That is, in the import order of FIG. 14A, the import of the import target files 52c and 52f similarly fails. The import target file (MS001.PRG) 52b, the import target file (STR3.TYP) 52e, and the import target file (USR_FUN1.FUN) 52h have no reference relationship with other files.

As described above, when the import order of the import target files 52 is not the order according to the reference relationship of the import target files 52, the importer 32 fails to import some of the import target files 52.

Conventionally, in order for the system programmer to correctly specify the import order, it is necessary to investigate the structure or the like stored in each import target file 52 and correctly grasp all the reference relationships. In a large-scale control program, since it takes time to investigate and calculate the import order, the burden on the system programmer increases and the development efficiency of the control program deteriorates.

FIG. 14B is a diagram illustrating an example in which the import order of respective import target files 52 is an order according to the reference relationship of the respective import target files 52. The importer 32 according to the embodiment of the present disclosure can automatically calculate the correct import order as illustrated in FIG. 14B based on the reference relationship of each import target file 52 even when the import order in FIG. 14A is designated. In FIG. 14B, the import target files 52d, 52c, 52g, 52f, 52a, 52e, 52h, and 52b are imported in this order.

In the following description, structures and the like stored in the import target files 52d, 52c, 52g, 52f, and 52a are referred to as a first structure, a second structure, a first function, a second function, and a program, respectively. In FIG. 14B, the second structure referring to the first structure is imported after the first structure. The first function that refers to the first structure is imported after the first structure. The second function that refers to the first function is imported after the first function. The program referring to the first function is imported after the first function.

In the example of FIG. 14B, an example in which the first function is a function and the second function is a function block that refers to the first function is illustrated, but the present embodiment is not limited to this example. For example, the first function may be a function, and the second function may be a function that refers to the first function. The first function may be a function block, and the second function may be a function block that refers to the first function. In either case, the first function and the second function are imported in this order.

Further, as described above, the first function that refers to the first structure is imported after the first structure, and the program that refers to the first function is imported after the first function. As described above, in this example, the first function is a function, but may be a function block.

As described above, in FIG. 14B, the import order is set such that the structure or the like of the reference source comes after the structure or the like of the reference destination, and thus, when the import is executed in the import order of FIG. 14B, none of the import target files 52a to 52h fails.

As described above, the engineering tool 1 automatically calculates the import order based on the reference relationship of each import target file. This eliminates the need for the system programmer to specify the import order, reduces the burden on the system programmer, and improves the development efficiency of the control program.

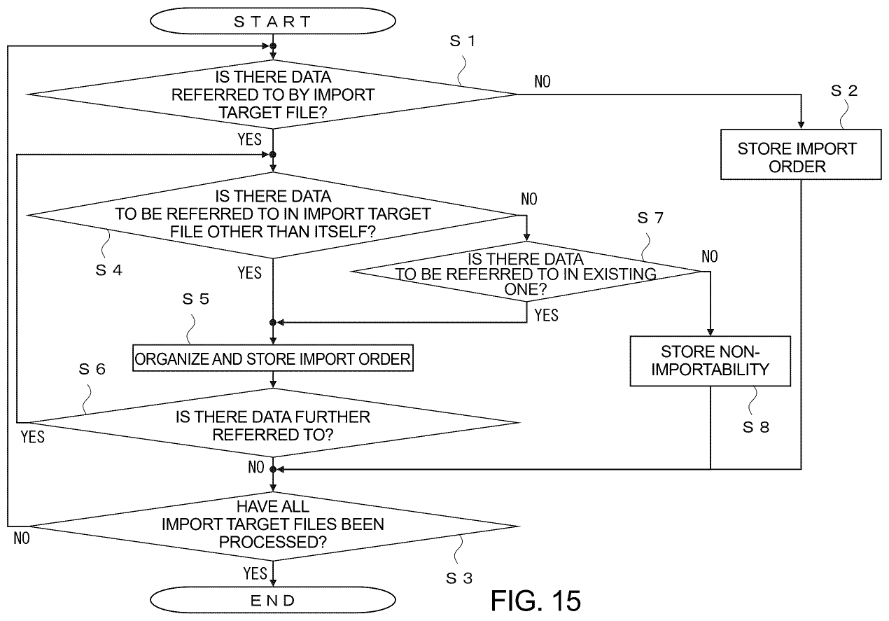

FIG. 15 is a flowchart of import order calculation according to the embodiment of the present disclosure. The importer 32 calculates the import order illustrated in FIG. 14B according to the flowchart of FIG. 15.

The importer 32 processes the plurality of import target files 52 one by one, for example, in the order specified by the system programmer. First, the importer 32 determines whether or not there is a structure or the like (hereinafter referred to as data) referred to by one import target file 52 to be processed (step S1).

When there is no data referred to by the target import target file 52, the importer 32 stores the import order as it is (step S2). For example, the import order is determined as the next value of the import order at the end of the file group of which the import order is currently determined, and the value of the determined import order is stored. The importer 32 determines whether all the import target files have been processed (step S3), and ends the import order calculation processing when all the import target files have been processed. When the processing has not been performed, the importer 32 performs the processing from step S1 on the import target file 52 to be processed next.

When there is data referred to by the target import target file 52 in step S1, the importer 32 determines whether there is data to be referred to in another import target file 52 (step S4).

When there is data to be referred to in another import target file 52, the importer 32 organizes and stores the import order (step S5). Specifically, the importer 32 organizes (rearranges) the import order such that the import target file 52 having data to be referred to is imported before the target import target file 52.

The importer 32 determines whether or not there is data further referred to by the target import target file 52 or the import target file 52 having data to be referred to (step S6). When there is data referred to by either the target import target file 52 or the import target file 52 having data to be referred to, the determination in step S4 is performed again. When there is no data referred to by either the target import target file 52 or the import target file 52 having data to be referred to, the determination in step S3 is performed.

In step S4, when there is no data to be referred to in another import target file 52, the importer 32 determines whether or not there is data to be referred to in the control program (hereinafter, an existing control program) in the library of the import destination (step S7). The existing control program includes, for example, one or a plurality of pieces of data imported before the current import operation in the library to be the import destination, and is stored in the database 4.

If there is data to be referred to in the existing control program, the data to be referred to does not need to be newly imported. Since the target import target file 52 is importable, the importer 32 stores the import order of the target import target file 52 in step S5. Thereafter, the determination in step S4 is similar to the case where there is data to be referred to in another import target file 52.

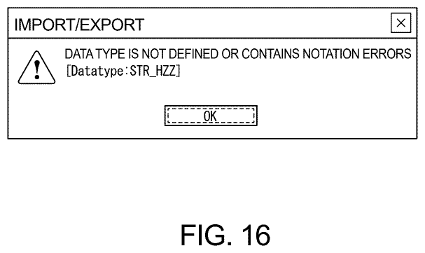

When there is no data to be referred to in the existing control program, the importer 32 determines that the target import target file 52 is non-importable, and stores information of non-importability (step S8). In this case, the importer 32 notifies the system engineer of the fact in, for example, a message window or the like. FIG. 16 is an example of a message window describing non-importability output by the importer 32. In FIG. 16, for example, the data type name (Datatype) of data to be referred to which could not be found from another import target file 52 and the existing control program is displayed.

After the non-importability of the import target file 52 is stored in step S8, the determination in step S3 is performed.

As described above, the importer 32 can calculate the import order in FIG. 14B by executing the processing of the flowchart in FIG. 15.

Further, in the flowchart of FIG. 15, data to be referred to is searched from the existing control program. That is, the importer 32 calculates the import order based on the data in the existing control program. Conventionally, when there is no file storing data to be referred to in the import target file 52, it is necessary to investigate in advance whether or not the data to be referred to exists in the existing control program (whether or not the data has been imported). In the embodiment of the present disclosure, as described above, since data to be referred to is automatically searched for from the existing control program, it is not necessary to investigate the existing control program.

In addition, the importer 32 according to the embodiment of the present disclosure can also improve the efficiency of the export operation. When reusing the control program to develop a new control program, the system programmer may export data necessary for the control program of the import destination from the control program of the reuse source from the engineering tool 1 as a file using the exporter 31. The system programmer imports the exported file into a new control program by the importer 32. Even in such a case, the importer 32 calculates the import order based on the data in the existing control program, so that the investigation of the reference relationship of the export target data and the investigation of the data to be referred in the existing control program, which are conventionally necessary, can be omitted or reduced. That is, the importer 32 can improve the efficiency of the export operation.

Hereinafter, a more specific method of calculating the import order for each structure, function, function block, and program constituting the control program will be described. Note that the flowchart of FIG. 15 may be applied to data other than structures, functions, function blocks, and programs.

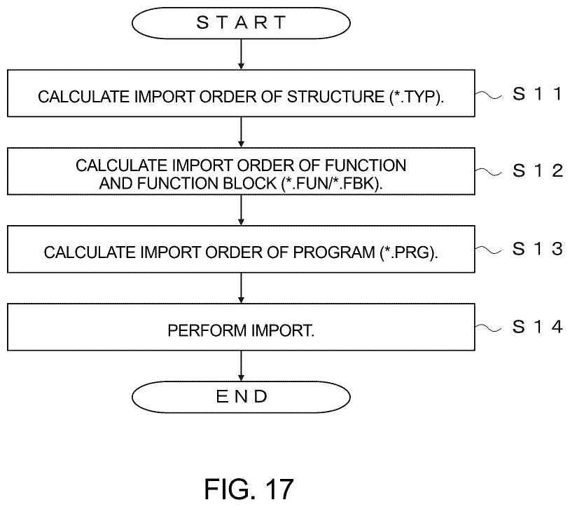

FIG. 17 is a flowchart of an overall import in an embodiment of the present disclosure. The importer 32 starts import processing of FIG. 17, for example, when the system programmer specifies a plurality of import target files 52 and presses the import button on the screen of FIG. 13.

The importer 32 first calculates the import order of the files of the structure (the import order of the structure) among the plurality of import target files 52 (step S11). Subsequently, the importer 32 calculates the import order of the function and function block files (the import order of the function and function block) among the plurality of import target files 52 (step S12). Subsequently, the importer 32 calculates the import order of the files of the programs (the import order of the programs) among the plurality of import target files 52 (step S13). Finally, the importer 32 imports the plurality of import target files 52 on the basis of the import order calculated in steps S11 to S13. That is, data (structure, function, function block, and program) included in the plurality of import target files 52 is imported.

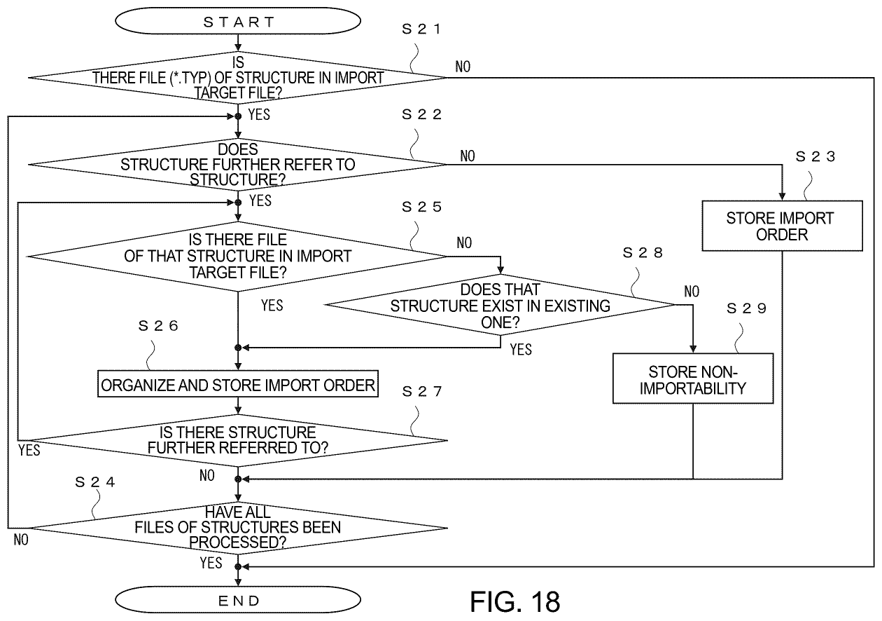

FIG. 18 is a flowchart of structure import order calculation. In step S11 in FIG. 17, the importer 32 executes the processing of the flowchart in FIG. 18.

The importer 32 determines whether or not there is a file storing a structure in the import target file 52 (step S21). The importer 32 can determine whether or not the import target file 52 stores a structure, for example, by an extension. For example, when the extension of the import target file 52 is *.TYP, the file stores a structure.

When there is no file storing the structure in the import target file 52, the importer 32 ends the processing of FIG. 18.

When there is a file storing a structure in the import target file 52, the importer 32 processes the import target files 52 storing a structure one by one. As described above, a structure may refer to other structures. Therefore, the importer 32 determines whether or not the structure (hereinafter, a structure to be processed) in the import target file 52 to be processed refers to another structure (step S22).

In step S22, as in step S1 in FIG. 15, when the structure to be processed does not refer to another structure, the importer 32 stores the import order of the files of the structure to be processed (step S23). Subsequently, the importer 32 determines whether all the files including the structure among the plurality of import target files 52 have been processed (step S24). When all the files including the structure have been processed, the importer 32 ends the processing of FIG. 18, and when there is a file that has not been processed, the determination in step S22 is performed on the next structure.

Further, when the structure to be processed refers to another structure, similarly to step S4 in FIG. 15, the importer 32 determines whether or not there is a file including another structure to be referred to in the import target file 52 (step S25), and if so, organizes and stores the import order (step S26). The importer 32 determines whether or not there is a structure that is further referred to in the structure to be processed and the structure to be referred to (step S27), and if so, performs the determination of step S25 again, and if not, proceeds to the determination of step S24.

When there is no file including a structure to be referred to in the import target file 52, the importer 32 determines whether or not the structure to be referred to exists in an existing control program (library of the import destination) (step S28), and if so, the processing proceeds to step S26, and if not, non-importability is stored (step S29), and the processing proceeds to the determination in step S24.

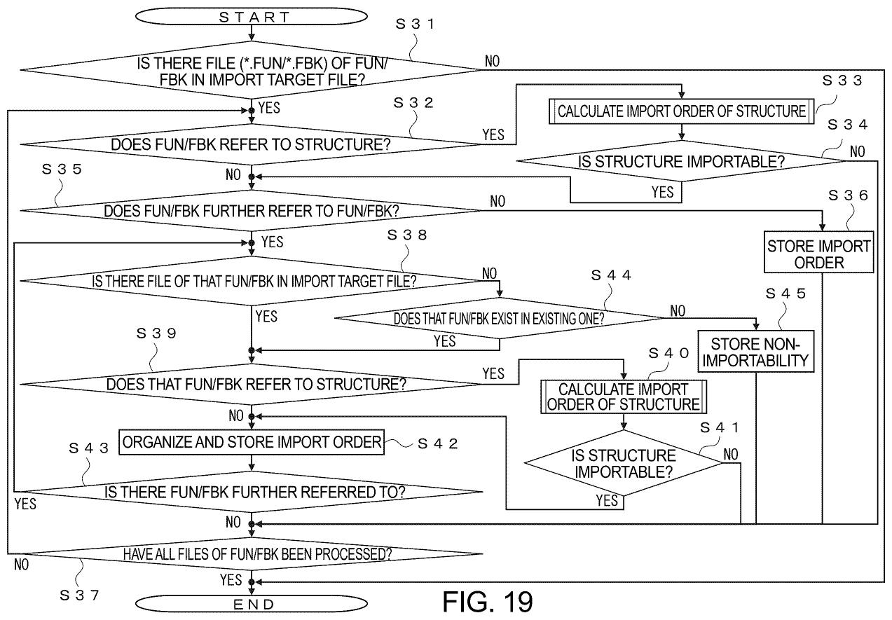

FIG. 19 is a flowchart of import order calculation of the function (hereinafter referred to as FUN) and the function block (hereinafter, referred to as FBK). After the processing of FIG. 18 is completed, the importer 32 executes the processing of the flowchart of FIG. 19 in step S12 of FIG. 17.

The importer 32 determines whether or not there is a file storing FUN and FBK among the import target files 52 (step S31), and if not, ends the processing of FIG. 19. For example, when the extension of the import target file 52 is *.FUN, the file stores FUN. When the extension of the import target file 52 is *.FBK, the file stores FBK.

As described above, FUN and FBK may refer to a structure, another FUN or another FBK. Therefore, the importer 32 determines whether or not the FUN or FBK to be processed refers to the structure (step S32). When the FUN or FBK to be processed refers to the structure, the importer 32 calculates the import order of the files of the structure (step S33).

Specifically, in step S33, the importer 32 performs the processing of steps S25 to S29 in FIG. 18. When there is no structure to be further referred to in the FUN or FBK to be processed and the structure to be referred in step S27 of FIG. 18, or when information of non-importability is stored in step S29, the importer 32 ends the processing of step S33 of FIG. 19.

In the processing of step S33, the importer 32 determines whether or not a file of a necessary structure is importable (step S34). Specifically, when the information indicating non-importability is stored in step S29 of FIG. 18, some or all of the files of the necessary structure are non-importable. When the file of the structure is non-importable, the file of FUN or FBK to be processed is non-importable. At this time, information of non-importability may be stored with respect to the file of FUN or FBK to be processed may be stored.

When it is determined in step S27 of FIG. 18 that there is no further structure to be referred to, all files of structures that need to be imported are importable.

When the FUN or FBK to be processed does not refer to the structure in step S32, or when it is determined that the structure is importable in step S34, the importer 32 determines whether or not the FUN or FBK to be processed refers to another FUN or FBK (step S35).

When the FUN or FBK to be processed does not refer to another FUN or FBK, the importer 32 stores the import order of the FUN or FBK to be processed (step S36). This processing may be similar to step S23 in FIG. 18.

After the processing of step S36 or when the structure is non-importable in step S34, the importer 32 determines whether all the files of FUN or FBK have been processed (step S37). When all the files of FUN or FBK have been processed, the importer 32 ends the processing of FIG. 19, and when all the files of FUN or FBK have not been processed, the importer proceeds to the determination in step S32 for the next file of FUN or FBK.

In step S35, when the FUN or FBK to be processed refers to another FUN or FBK, the importer 32 determines whether or not the file of the FUN or FBK to be referred to exists in the import target file 52 (step S38).

When the file of FUN or FBK to be referred to is present in the import target file 52, the importer 32 determines whether or not the FUN or FBK further refers to a structure (step S39). When the FUN or FBK to be referred to further refers to the structure, the importer 32 calculates the import order of the files of the structure as in step S33 (step S40). In the processing of step S40, the importer 32 determines whether or not a file of a necessary structure is importable (step S41). When the file of the structure is non-importable, the importer 32 stores information indicating that the file of the FUN or FBK to be processed is non-importable, and the processing proceeds to the determination in step S37.

When the FUN or FBK referred to in step S39 does not further refer to the structure, or when it is determined in step S40 that the file of the structure is importable, the importer 32 organizes and stores the import order (step S42), and further determines whether or not there is a FUN or FBK that is further referred to (step S43). If there is FUN or FBK further referred to in step S43, the importer 32 proceeds to the determination in step S38, and if not, proceeds to the determination in step S37.

In step S38, when the file of FUN or FBK to be referred to is not in the import target file 52, the importer 32 determines whether or not the file of FUN or FBK to be referred to is in an existing control program (step S44), and if so, the processing proceeds to step S39, and if not, information of non-importability is stored (step S45), and the processing proceeds to the determination in step S37.

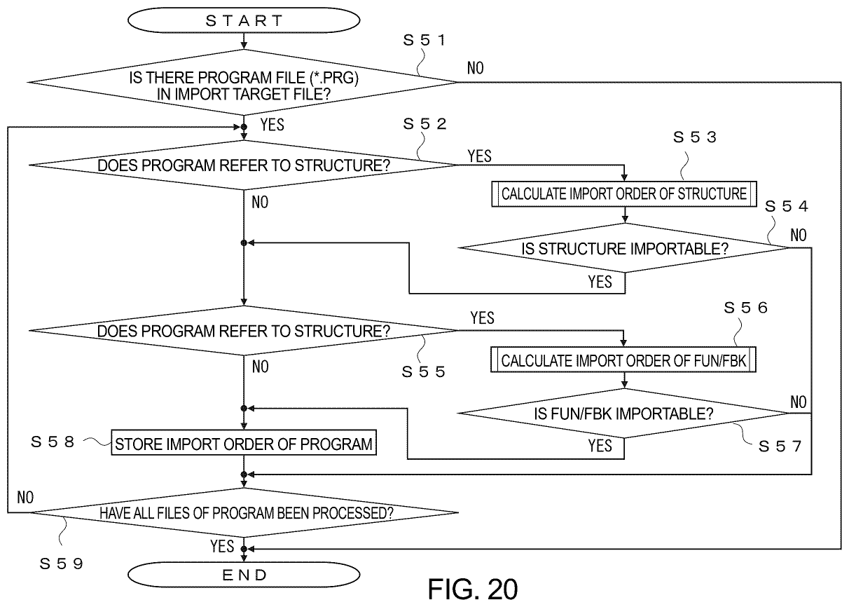

FIG. 20 is a flowchart of calculation of the import order of the program. After the processing of FIG. 19 is completed, the importer 32 executes the processing of the flowchart of FIG. 20 in step S13 of FIG. 17.

The importer 32 determines whether or not there is a file storing a program in the import target file 52 (step S51), and ends the processing of FIG. 20 when there is no file. For example, when the extension of the import target file 52 is *.PRG, the file stores a program.

As described above, the program may refer to the structure, FUN, or FBK. Therefore, the importer 32 determines whether or not the program to be processed refers to the structure (step S52). When the program to be processed refers to the structure, the importer 32 calculates the import order of the structure as in step S33 in FIG. 19 (step S53). In the processing of step S53, the importer 32 determines whether or not a file of a necessary structure is importable (step S54).

When the program to be processed does not refer to the structure in step S52, or when it is determined that the file of the structure is importable in step S54, the importer 32 determines whether or not the program to be processed refers to FUN or FBK (step S55). If it is determined in step S54 that the file of the structure is non-importable, the file of the program to be processed is non-importable.

When the program to be processed refers to FUN or FBK in step S55, the importer 32 calculates the import order of the file of FUN or FBK (step S56). Specifically, the importer 32 performs the processing of steps S35 to S43 in FIG. 19. When the program to be processed and the FUN or FBK to be referred to do not further include the FUN or FBK to be referred to in step S43 of FIG. 19, or when information of non-importability of the file of the program to be processed is stored in step S45, or when it is determined in step S41 that the structure to be referred to by the FUN or FBK is non-importable, the importer 32 ends the processing of step S56 of FIG. 20.

After step S56, the importer 32 determines whether or not the file of FUN or FBK is importable (step S57). Specifically, when it is stored in step S45 that the file of the program to be processed is non-importable, or when it is determined in step S41 that the file of the structure referred to by FUN or FBK is non-importable, the file of FUN or FBK is non-importable. That is, when it is determined that the file of FUN or FBK is non-importable, the file of the program to be processed is non-importable.

When it is determined in step S43 of FIG. 19 that there is no FUN or FBK to be further referred to, all files of FUN or FBK that need to be imported are importable.

When the program to be processed does not refer to FUN or FBK in step S55, or when it is determined that FUN or FBK is importable in step S57, the importer 32 stores the import order of the files of the program (step S58).

When the import order of the files of the program is stored in step S58, when it is determined in step S54 that the file of the structure is non-importable, or when it is determined in step S57 that the file of FUN or FBK is non-importable, the importer 32 determines whether all the files of the program have been processed (step S59). When all the files of the program have been processed, the importer 32 ends the processing of FIG. 20, and when all the files of the program have not been processed, the processing proceeds to the determination of step S52 for the file of the next program.

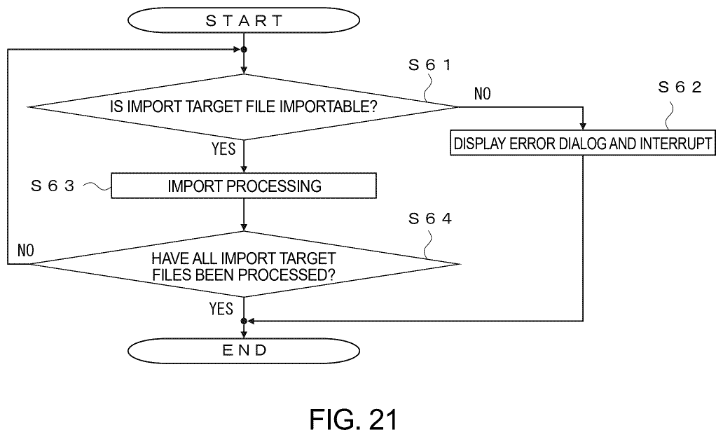

FIG. 21 is a flowchart of the import processing. After the processing of FIG. 20 is completed, the importer 32 executes the processing of the flowchart of FIG. 21 in step S14 of FIG. 17.

The importer 32 processes the import target files 52 one by one in the import order of the import target files organized in steps S11 to S13 in FIG. 17. First, the importer 32 determines whether or not the import target file 52 to be processed is importable (step S61).

In step S29 in FIG. 18, step S45 in FIG. 19, and the like, the import target file 52 in which import prohibition is stored is non-importable. When it is determined in the determination of step S61 that it is non-importable, an error dialog (for example, the dialog in FIG. 16) is displayed (step S62), and the processing of FIG. 21 is interrupted.

If it is not determined in step S61 that the file is non-importable, that is, if it is determined that the file is importable, the import target file 52 to be processed is imported (step S63). Subsequently, it is determined whether all the import target files have been processed (step S64). When all the import target files 52 have not been processed, the importer 32 makes the determination in step S61 for the next import target file 52 to be processed. When all the import target files 52 have been processed in step S64, or when the processing of FIG. 21 has been interrupted in step S62, the processing of FIG. 21 ends and the processing of FIG. 17 also ends.

As described above, the engineering tool 1 according to the embodiment of the present disclosure automatically calculates the import order based on the reference relationship between the data (structure, function, function block, program, and the like) of the control program, and imports the import target file in the optimum order. Therefore, the system programmer can import the import target file without correctly specifying the import order of the import target file. In addition, it is possible to eliminate or reduce the need for the system programmer to investigate the reference relationship between the import target files. In addition, the engineering tool 1 according to the embodiment of the present disclosure searches for data to be imported from the existing control program when there is no file of data to be imported in a group of import target files, and thus, it is possible to reduce the time and effort for the system programmer to investigate whether or not there is data to be imported in the existing control program. That is, the engineering tool 1 can improve the efficiency of the import and export of the control program.

Note that the present invention is not limited to the above-described embodiments as they are, and can be embodied by modifying the components without departing from the gist thereof at the implementation stage. In addition, various inventions can be formed by appropriately combining a plurality of components disclosed in the above embodiments. Further, for example, a configuration in which some components are deleted from all the components illustrated in each embodiment is also conceivable. Furthermore, components described in different embodiments may be appropriately combined.

### SUPPLEMENTARY NOTE

### Item 1

An engineering tool including:
an importer that imports a plurality of structures each having at least one variable or array, in which
the importer determines an import order so as to import a structure that refers to another structure among the plurality of structures later than the another structure of the plurality of structures, and imports the plurality of structures in the determined import order.

### Item 2

The engineering tool according to item 1, in which
the importer imports a plurality of functions each including a function or a function block, and
the importer determines an import order of the plurality of functions so as to import a function that refers to another function among the plurality of functions after the another function, and imports the plurality of functions in the determined import order.

### Item 3

The engineering tool according to item 2, in which
the importer imports a program that refers to at least one of the functions, and
the importer determines an import order of the program and a function referred to by the program so as to import the program after the function, and imports the program and the function in the determined import order.

### Item 4

The engineering tool according to item 3, in which
the importer imports the program from an import target file defining the program among a plurality of import target files each defining the function and the program, and
when a file defining a function referred to from the program is not present in the plurality of import target files, it is determined whether the function has been imported to a library of an import destination, and when the function has been imported, an import order of the program and the function is determined, and when the function has not been imported, it is determined that the program is non-importable.

### Item 5

The engineering tool according to any one of items 2 to 4, in which
the importer imports the plurality of functions from a plurality of import target files each defining the plurality of functions, and
when an import target file defining a function to be referred to from any of the plurality of functions is not present in the plurality of import target files, it is determined whether the function to be referred to has been imported into a library of an import destination, and when the function to be referred to has been imported, an import order of the plurality of functions is determined, and when the function to be referred to has not been imported, it is determined that the function that refers to the function to be referred to is non-importable.

### Item 6

The engineering tool according to any one of items 1 to 4, in which
the importer imports the plurality of structures from a plurality of import target files each defining the plurality of structures, and
when an import target file defining a structure to be referred to from any of the plurality of structures is not present in the plurality of import target files, it is determined whether the structure to be referred to has been imported into a library of an import destination, and when the structure to be referred to has been imported, an import order of the plurality of structures is determined, and when the structure to be referred to has not been imported, it is determined that the structure that refers to the structure to be referred to is non-importable.

### Item 7

The engineering tool according to item 3 or 4, in which
an aggregate imported by the importer of the program, the plurality of functions, and the plurality of structures constitute a control program for controlling a control device.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An engineering tool comprising:
an importer that imports a plurality of structures each having at least one variable or array, wherein
the importer determines an import order so as to import a structure that refers to another structure among the plurality of structures later than the another structure of the plurality of structures, and imports the plurality of structures in the determined import order.

2. The engineering tool according to claim 1, wherein
the importer imports a plurality of functions each including a function or a function block, and
the importer determines an import order of the plurality of functions so as to import a function that refers to another function among the plurality of functions after the another function, and imports the plurality of functions in the determined import order.

3. The engineering tool according to claim 2, wherein
the importer imports a program that refers to at least one of the functions, and
the importer determines an import order of the program and a function referred to by the program so as to import the program after the function, and imports the program and the function in the determined import order.

4. The engineering tool according to claim 3, wherein
the importer imports the program from an import target file defining the program among a plurality of import target files each defining the function and the program, and
when a file defining a function referred to from the program is not present in the plurality of import target files, it is determined whether the function has been imported to a library of an import destination, and when the function has been imported, an import order of the program and the function is determined, and when the function has not been imported, it is determined that the program is non-importable.

5. The engineering tool according to claim 2, wherein
the importer imports the plurality of functions from a plurality of import target files each defining the plurality of functions, and
when an import target file defining a function to be referred to from any of the plurality of functions is not present in the plurality of import target files, it is determined whether the function to be referred to has been imported into a library of an import destination, and when the function to be referred to has been imported, an import order of the plurality of functions is determined, and when the function to be referred to has not been imported, it is determined that the function that refers to the function to be referred to is non-importable.

6. The engineering tool according to claim 3, wherein
the importer imports the plurality of functions from a plurality of import target files each defining the plurality of functions, and
when an import target file defining a function to be referred to from any of the plurality of functions is not present in the plurality of import target files, it is determined whether the function to be referred to has been imported into a library of an import destination, and when the function to be referred to has been imported, an import order of the plurality of functions is determined, and when the function to be referred to has not been imported, it is determined that the function that refers to the function to be referred to

7. The engineering tool according to claim 4, wherein
the importer imports the plurality of functions from a plurality of import target files each defining the plurality of functions, and
when an import target file defining a function to be referred to from any of the plurality of functions is not present in the plurality of import target files, it is determined whether the function to be referred to has been imported into a library of an import destination, and when the function to be referred to has been imported, an import order of the plurality of functions is determined, and when the function to be referred to has not been imported, it is determined that the function that refers to the function to be referred to is non-importable.

8. The engineering tool according to claim 1, wherein
the importer imports the plurality of structures from a plurality of import target files each defining the plurality of structures, and
when an import target file defining a structure to be referred to from any of the plurality of structures is not present in the plurality of import target files, it is determined whether the structure to be referred to has been imported into a library of an import destination, and when the structure to be referred to has been imported, an import order of the plurality of structures is determined, and when the structure to be referred to has not been imported, it is determined that the structure that refers to the structure to be referred to is non-importable.

9. The engineering tool according to claim 2, wherein
the importer imports the plurality of structures from a plurality of import target files each defining the plurality of structures, and
when an import target file defining a structure to be referred to from any of the plurality of structures is not present in the plurality of import target files, it is determined whether the structure to be referred to has been imported into a library of an import destination, and when the structure to be referred to has been imported, an import order of the plurality of structures is determined, and when the structure to be referred to has not been imported, it is determined that the structure that refers to the structure to be referred to is non-importable.

10. The engineering tool according to claim 3, wherein
the importer imports the plurality of structures from a plurality of import target files each defining the plurality of structures, and
when an import target file defining a structure to be referred to from any of the plurality of structures is not present in the plurality of import target files, it is determined whether the structure to be referred to has been imported into a library of an import destination, and when the structure to be referred to has been imported, an import order of the plurality of structures is determined, and when the structure to be referred to has not been imported, it is determined that the structure that refers to the structure to be referred to is non-importable.

11. The engineering tool according to claim 4, wherein
the importer imports the plurality of structures from a plurality of import target files each defining the plurality of structures, and
when an import target file defining a structure to be referred to from any of the plurality of structures is not present in the plurality of import target files, it is determined whether the structure to be referred to has been imported into a library of an import destination, and when the structure to be referred to has been imported, an import order of the plurality of structures is determined, and when the structure to be referred to has not been imported, it is determined that the structure that refers to the structure to be referred to is non-importable.

12. The engineering tool according to claim 5, wherein
the importer imports the plurality of structures from a plurality of import target files each defining the plurality of structures, and
when an import target file defining a structure to be referred to from any of the plurality of structures is not present in the plurality of import target files, it is determined whether the structure to be referred to has been imported into a library of an import destination, and when the structure to be referred to has been imported, an import order of the plurality of structures is determined, and when the structure to be referred to has not been imported, it is determined that the structure that refers to the structure to be referred to is non-importable.

13. The engineering tool according to claim 6, wherein
the importer imports the plurality of structures from a plurality of import target files each defining the plurality of structures, and
when an import target file defining a structure to be referred to from any of the plurality of structures is not present in the plurality of import target files, it is determined whether the structure to be referred to has been imported into a library of an import destination, and when the structure to be referred to has been imported, an import order of the plurality of structures is determined, and when the structure to be referred to has not been imported, it is determined that the structure that refers to the structure to be referred to is non-importable.

14. The engineering tool according to claim 7, wherein
the importer imports the plurality of structures from a plurality of import target files each defining the plurality of structures, and
when an import target file defining a structure to be referred to from any of the plurality of structures is not present in the plurality of import target files, it is determined whether the structure to be referred to has been imported into a library of an import destination, and when the structure to be referred to has been imported, an import order of the plurality of structures is determined, and when the structure to be referred to has not been imported, it is determined that the structure that refers to the structure to be referred to is non-importable.

15. The engineering tool according to claim 3, wherein
an aggregate imported by the importer of the program, the plurality of functions, and the plurality of structures constitute a control program for controlling a control device.

16. The engineering tool according to claim 4, wherein
an aggregate imported by the importer of the program, the plurality of functions, and the plurality of structures constitute a control program for controlling a control device.

17. The engineering tool according to claim 6, wherein
an aggregate imported by the importer of the program, the plurality of functions, and the plurality of structures constitute a control program for controlling a control device.

18. The engineering tool according to claim 7, wherein
an aggregate imported by the importer of the program, the plurality of functions, and the plurality of structures constitute a control program for controlling a control device.

19. The engineering tool according to claim 10, wherein
an aggregate imported by the importer of the program, the plurality of functions, and the plurality of structures constitute a control program for controlling a control device.

20. The engineering tool according to claim 11, wherein
an aggregate imported by the importer of the program, the plurality of functions, and the plurality of structures constitute a control program for controlling a control device.
